(19) United States
(12) Patent Application Publication
(10) Pub. No.: US 2026/0250796 A1
(43) Pub. Date: Aug. 27, 2026

(54) MAGNETICALLY ENHANCED INDUCTION HEAT TREATING APPLICATION

(71) Applicant: AJAX TOCCO MAGNETHERMIC CORPORATION, Warren, OH (US)

(72) Inventors: Ronald AKERS, Guntersville, AL (US); David A. LAZOR, Girard, OH (US); George P. WELCH, Warren, OH (US)

(73) Assignee: AJAX TOCCO MAGNETHERMIC CORPORATION, Warren, OH (US)

(21) Appl. No.: 18/859,771

(22) PCT Filed: Apr. 18, 2023
(86) PCT No.: PCT/US2023/018886

§ 371 Date: Oct. 24, 2024

Related U.S. Application Data
(60) Provisional application No. 63/334,242, filed on Apr. 25, 2022.

(51) Int. Cl. C21D 1/42; C21D 1/18; C21D 9/08; H05B 6/40; H05B 6/44

(52) U.S. Cl. CPC C21D 1/42; C21D 1/18; C21D 9/085; H05B 6/40; H05B 6/44

(57) ABSTRACT

Induction heating systems and methods, in which a DC magnetic field is applied to a magnetic workpiece while one or more induction heating coils are energized with AC current for an induction heating process. The heat treatment of the workpiece can be tailored to a achieve a desired thermal profile by controlling the workpiece permeability through the strength of the applied DC magnetic field in combination with control of the induction coil frequency, and the system can be adapted to different workpieces and target thermal profiles by controlling the relative permeability of the workpiece through DC magnetic field strength adjustment or setting and induction heating power, frequency and processing time.

### BACKGROUND

Induction heating generates heat within the subsurface of a workpiece through induced current flow in the workpiece. The penetration depth of the heat distribution in the workpiece can be adjusted by the proximity and relative positioning of an induction heating coil to the workpiece, as well as the amplitude and frequency of the AC power applied to the induction heating coil. Induction thermomagnetic processing combines induction heating and heat treating with superconducting magnets to apply an AC magnetic field to enhance microstructure, material and mechanical properties of the workpiece, improve efficiency and reduce processing time. The induction heating coils are powered with an AC current at an induction coil, and the frequency has been used to control the depth of penetration and therefore the thermal profile along with the traditional variables of power and time. However, adapting induction heating apparatus to a particular workpiece design and a given set of heat-treating specifications through induction coil frequency adjustments can be difficult. Varying the induction coil frequency by an order of magnitude to adapt an existing system for a different workpiece typically requires a power supply with an entirely different set of power devices and magnetic components, which is costly and can be impractical. Other solutions include combining dual frequency power supplies, some in sequence and others with simultaneous frequency applications, such as for induction heating gears. These approaches, however, increase system cost and complexity.

### SUMMARY

Systems and methods are described, in which a DC magnetic field is applied to a magnetic workpiece while one or more induction heating coils are energized with AC current. The heat treatment of the workpiece can be tailored to a achieve a desired thermal profile by controlling the workpiece permeability through the strength of the applied DC magnetic field in combination with control of the induction coil frequency. The described examples enable adaptation of induction heating systems to a variety of different workpieces and target thermal profiles by controlling the relative permeability of the workpiece through DC magnetic field strength adjustment or setting.

### BRIEF DESCRIPTION OF THE DRAWINGS

FIG. 1 is a partial schematic diagram of an induction heating system for heat treating having a DC magnet and a solenoid induction heating coil circumferentially surrounding a concentric workpiece.

FIG. 1A is a perspective view of a workpiece with first and second splines.

FIG. 2 is a partial schematic diagram of an induction heating system having a DC magnet and a single shot induction heating coil for heat treating a rotating workpiece.

FIG. 3 is a partial schematic diagram of an induction heating system for tempering having a DC magnet and a solenoid induction heating coil circumferentially surrounding a concentric workpiece.

FIG. 4 is a flow diagram of an induction heat treating method.

FIG. 5 is a cross-sectional simulated thermal profile of a workpiece heat treated by induction heating using a solenoid induction coil at a coil frequency of 2.6 kHz without a DC magnetic field.

FIG. 6 is a graph of workpiece temperature as a function of time for the tip of the workpiece tooth, the base of the root, a 3 mm depth from the root and a target temperature for the workpiece heat treated using the solenoid induction coil at a frequency of 2.6 kHz without a DC magnetic field.

FIG. 7 is a cross-sectional simulated thermal profile of a workpiece heat treated by induction heating using a solenoid induction coil at a coil frequency of 10.0 kHz with a 2 Tesla DC magnetic field.

FIG. 8 is a graph of workpiece temperature as a function of time for the tip of the workpiece tooth, the base of the root, a 3 mm depth from the root and a target temperature for the workpiece heat treated using a solenoid induction coil at a coil frequency of 10.0 kHz with a 2 Tesla DC magnetic field.

FIG. 9 shows depth of current penetration formulas and parameters.

FIG. 10 is a cross-sectional simulated thermal profile of a workpiece heat treated by induction heating using a solenoid induction coil at a coil frequency of 17.0 kHz with a 2 Tesla DC magnetic field.

FIG. 11 is a graph of workpiece temperature as a function of time for the tip of the workpiece tooth, the base of the root, a 3 mm depth from the root and a target temperature for the workpiece heat treated using a solenoid induction coil at a coil frequency of 17.0 kHz with a 2 Tesla DC magnetic field.

FIG. 12 is a cross-sectional simulated thermal profile of a workpiece heat treated by induction heating using a solenoid induction coil at a coil frequency of 20.0 kHz with a 2 Tesla DC magnetic field.

FIG. 13 is a graph of workpiece temperature as a function of time for the tip of the workpiece tooth, the base of the root, a 3 mm depth from the root and a target temperature for the workpiece heat treated using a solenoid induction coil at a coil frequency of 20.0 kHz with a 2 Tesla DC magnetic field.

FIG. 14 shows a table of gear analysis temperature results data temperature for the workpiece heat treated using a solenoid induction coil for the simulated cases of FIGS. 5-13.

FIG. 15 shows a table of gear analysis power and energy results data temperature for the workpiece heat treated using a solenoid induction coil for the simulated cases of FIGS. 5-13.

FIG. 16A-16F our data table showing shaft magnetic cycle scanning analysis and parameter optimization for concurrent DC magnetic field and induction heating application for heat treatment.

FIG. 17 is a table of simulated hardness and penetration depth results for a 100 mm diameter shaft.

FIG. 18 is a table of preliminary shaft magnetic cycle scanning calculations for a 100 mm diameter shaft.

FIG. 19 is a table of simulated hardness and penetration depth results for a 120 mm diameter shaft.

FIGS. 20A-20C are tables of data results for a 100 mm diameter shaft.

FIG. 20D is a sectional side view of a workpiece.

FIG. 20E is a table of workpiece data for the workpiece of FIG. 20D.

### DETAILED DESCRIPTION

In the drawings, like reference numerals refer to like elements throughout, and the various features are not necessarily drawn to scale. One or more operational characteristics of various circuits, systems and/or components are hereinafter described in the context of functions which in some cases result from configuration and/or interconnection of various structures when a system or its components are powered and operating.

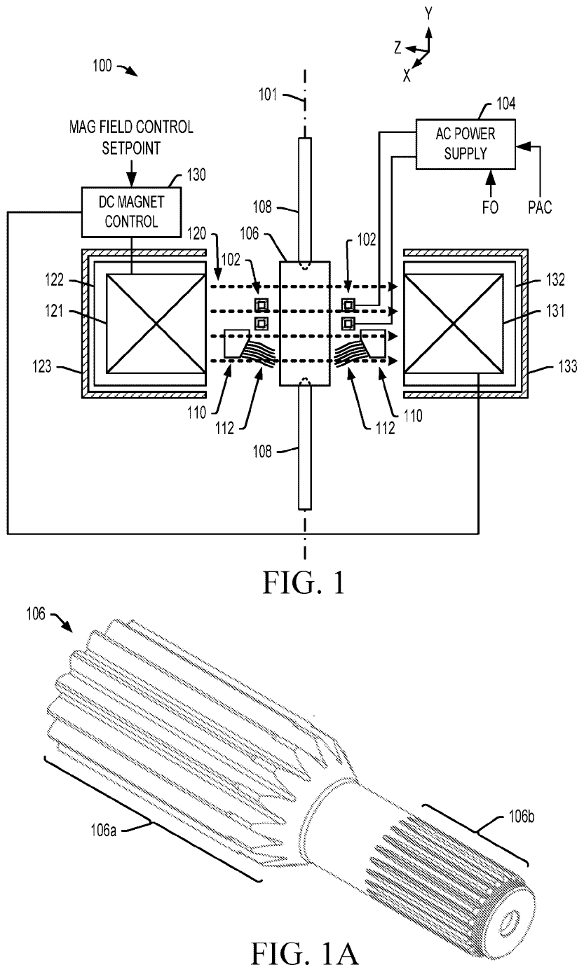

Referring initially to FIGS. 1 and 1A, FIG. 1 shows an induction heating system 100 for heat treating and FIG. 1A shows an example workpiece 106. The workpiece 106 in this example has a first spline 106a and a second spline 106b. In one example, the first spline 106a is heat treated at a linear translation speed of about 2.8 mm/second and the second spline 106 b is heat treated at a linear translation speed of about 2.0 mm/second. The workpiece 106 in one example includes a shaft made from 4320 material carburized and induction hardened. In one example, the induction heating system 100 scans the part or workpiece 106 with a 4.063″ ID (inner diameter) by 1″ long integral quench induction heating coil 102. The induction heating system 100 includes a DC magnet and a solenoid type induction heating coil 102 that circumferentially surrounds the concentric workpiece 106 along an axis or workpiece path 101 along which the workpiece 106 is translated for heat treating. The solenoid induction heating coil 102 circumferentially surrounds and is proximate to the workpiece path 101. The induction heating coil 102 is coupled to an AC power supply 104 to operate at an operating frequency FO to inductively heat the magnetic workpiece 106. The AC supply 104 is configured to control a magnitude and frequency of AC current provided to the induction heating coil 102 during induction heating for induction heating power control, and the duration of the heat-treating process is controlled. The system 100 includes scanner control supports 108 disposed at opposite ends of the workpiece 106 to support and optionally rotate the magnetic workpiece 106 about the axis of the workpiece path 101 during induction heating. In one implementation, the induction heating system 100 includes a quench system with outlets 110 that are axially spaced apart from the induction heating coil 102 (e.g., below the coil 102 in the example of FIG. 1). The quench system is configured to direct a quench fluid 112 onto the magnetic workpiece 106, for example, after induction heating.

The induction heating system 100 includes a DC magnet having opposite first and second poles 121 and 131 respectively facing opposite lateral sides of the magnetic workpiece 106. A first ferrous material structure 122 surrounds coils of the first magnetic pole 121, and a copper shield structure 123 extends around three sides of the ferrous material structure 122. A second ferrous material structure 132 surrounds coils of the second magnetic pole 131, and a second copper shield structure 133 extends around three sides of the second ferrous material structure 132. The first and second magnet poles 121 and 131 are equally spaced from the magnetic workpiece 106 on opposite sides thereof to provide a generally uniform DC magnetic field 120 to the magnetic workpiece 106 during induction heating by the induction heating coil 102. The coils of the first and second DC magnet poles 121 and 131 in one example are provided with current to set the field strength of the DC magnetic field 120 by a DC magnetic controller 130. In other implementations, different numbers and arrangements of magnet poles of these or different shapes can be used. In practice, a large or small DC magnet can be used in the induction heating system 100, as well as in the system's 200 and 300 described further below). For example, a small 12″ ID by 6″ tall or 12″ tall electromagnet can be installed in a scanner of an existing induction heating system, and the scanner can be designed to accommodate the magnetic forces of the applied DC magnetic field 120, with otherwise little change from existing induction heating system structures. In one example, a conventional DC magnet can be used, or a superconducting magnet can be used, for example, to apply a DC magnetic field 120 on the order of single digit T (Tesla) or even lower, to the magnetic workpiece 106.

The controller 130 is configured to control the strength of the DC magnetic field 120 applied to the magnetic workpiece 106 during induction heating by the induction heating coil 102 according to a magnetic field control setpoint, and the AC power supply 104 is configured to control the power level (e.g., current amplitude) according to an AC power setpoint PAC and operating frequency FO of the induction heating coil 102 according to an operating frequency setpoint FO, as well as the processing time according to parameters determined based on a specified or desired thermal profile for the magnetic workpiece 106 including a desired current penetration depth. In operation in one example, the induction heating coil 102 is energized by the AC power supply 104 providing AC current thereto in order to operate at the operating frequency FO, such as 5-100 kHz. The operating frequency FO and output amplitude (e.g., voltage and/or current) are adjustable or programmed in one implementation for a desired heat-treating profile for a particular workpiece 106. In addition, the magnetic field strength of the DC magnetic field 120 is controlled in order to control the permeability of the magnetic workpiece 106 during induction heating.

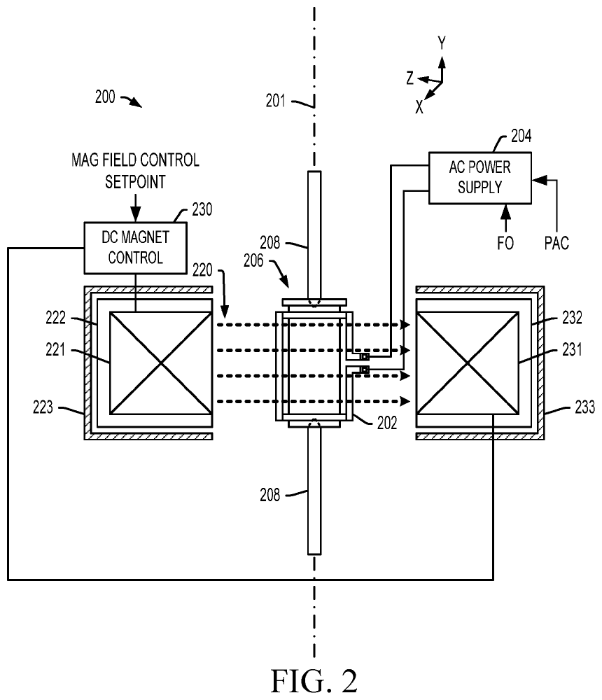

FIG. 2 is a partial schematic diagram of another induction heating system 200 having a DC magnet and a single shot induction heating coil 202 for heat treating a rotating magnetic workpiece 206. In this example, the induction heating coil 202 is a single shot coil having first and second conductors extending parallel to the workpiece path 201 and first and second crossover conductors. In the illustrated example, moreover, the magnetic workpiece 206 includes a cylindrical portion having a flange at one end, and the crossover conductor nearest the flange can be modified or tailored (e.g., by including diverging legs, not shown) to provide enhanced induction heating of a fillet portion. The induction heating coil 202 is coupled to an AC power supply 204 to operate at an operating frequency FO to inductively heat the magnetic workpiece 206. The AC supply 204 is configured to control a magnitude and frequency of AC current provided to the induction heating coil 202 during induction heating for induction heating power control, and the AC power supplied 204 controls the duration of the heat-treating process. The system 200 includes scanner control supports 208 disposed at opposite ends of the workpiece 206 to support and optionally rotate the magnetic workpiece 206 about the axis of the workpiece path 201 during induction heating.

The induction heating system 200 includes a DC magnet having opposite first and second poles 221 and 231 respectively facing opposite lateral sides of the magnetic workpiece 206. A first ferrous material structure 222 surrounds coils of the first magnetic pole 221, and a copper shield structure 223 extends around three sides of the ferrous material structure 222. A second ferrous material structure 232 surrounds coils of the second magnetic pole 231, and a second copper shield structure 233 extends around three sides of the second ferrous material structure 232. The first and second magnet poles 221 and 231 are equally spaced from the magnetic workpiece 206 on opposite sides thereof to provide a generally uniform DC magnetic field 220 to the magnetic workpiece 206 during induction heating by the induction heating coil 202. The coils of the first and second DC magnet poles 221 and 231 in one example are provided with current to set the field strength of the DC magnetic field 220 by a DC magnetic controller 230. In other implementations, different numbers and arrangements of magnet poles of these or different shapes can be used.

The controller 230 is configured to control the strength of the DC magnetic field 220 applied to the magnetic workpiece 206 during induction heating by the induction heating coil 202 according to a magnetic field control setpoint, and the AC power supply 204 is configured to control the power level (e.g., current amplitude) according to an AC power setpoint PAC and operating frequency FO of the induction heating coil 102 according to an operating frequency setpoint FO, as well as the processing time according to parameters determined based on a specified or desired thermal profile for the magnetic workpiece 206 including a desired current penetration depth. In operation in one example, the induction heating coil 202 is energized by the AC power supply 204 providing AC current thereto in order to operate at the operating frequency FO, such as 5-100 kHz. The operating frequency FO and output amplitude (e.g., voltage and/or current) are adjustable or programmed in one implementation for a desired heat-treating profile for a particular workpiece 206. In addition, the magnetic field strength of the DC magnetic field 220 is controlled in order to control the permeability of the magnetic workpiece 206 during induction heating.

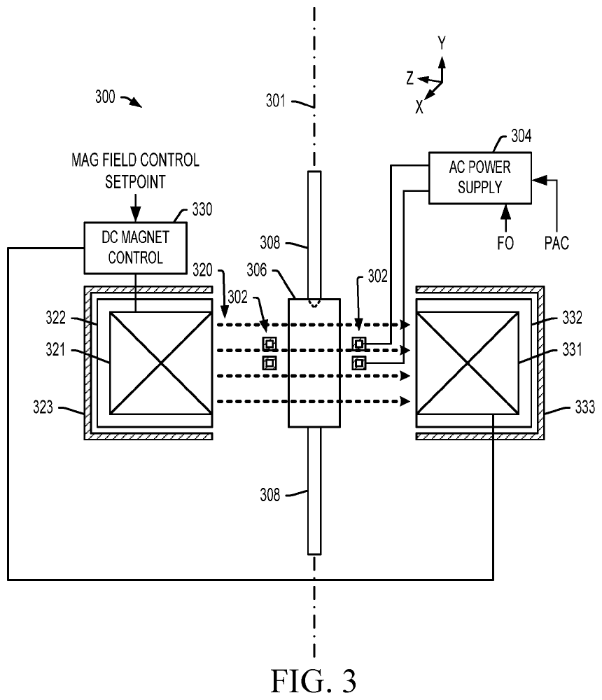

FIG. 3 is a partial schematic diagram of an induction heating system 300 for tempering a magnetic workpiece 306. The induction heating system 300 in FIG. 3 includes a DC magnet and a solenoid induction heating coil circumferentially surrounding a concentric workpiece. In operation, the system 300 is controlled to provide a lower level of induction heating to magnetic workpiece 306, for example, in order to repair the microstructure of the workpiece 306 following higher temperature induction heating and high temperature gradient quenching (not shown). The induction heating system 300 includes a DC magnet and a solenoid induction heating coil 302 that circumferentially surrounds the concentric workpiece 306 along an axis or workpiece path 301 along which the workpiece 306 is translated for heat treating. The solenoid induction heating coil 302 circumferentially surrounds and is proximate to the workpiece path 301. The induction heating coil 302 is coupled to an AC power supply 304 to operate at an operating frequency FO to inductively heat the magnetic workpiece 306. The AC supply 304 is configured to control a magnitude and frequency of AC current provided to the induction heating coil 302 during induction heating for induction heating power control, and the duration of the tempering process is controlled. The system 300 includes scanner control supports 308 disposed at opposite ends of the workpiece 306 to support and optionally rotate the magnetic workpiece 306 about the axis of the workpiece path 301 during induction heating.

The induction heating system 300 includes a DC magnet having opposite first and second poles 321 and 331 respectively facing opposite lateral sides of the magnetic workpiece 306. A first ferrous material structure 322 surrounds coils of the first magnetic pole 321, and a copper shield structure 323 extends around three sides of the ferrous material structure 322. A second ferrous material structure 332 surrounds coils of the second magnetic pole 331, and a second copper shield structure 333 extends around three sides of the second ferrous material structure 332. The first and second magnet poles 321 and 331 are equally spaced from the magnetic workpiece 306 on opposite sides thereof to provide a generally uniform DC magnetic field 320 to the magnetic workpiece 306 during induction heating by the induction heating coil 302. The coils of the first and second DC magnet poles 321 and 331 in one example are provided with current to set the field strength of the DC magnetic field 320 by a DC magnetic controller 330. In other implementations, different numbers and arrangements of magnet poles of these or different shapes can be used.

The controller 330 is configured to control the strength of the DC magnetic field 320 applied to the magnetic workpiece 306 during induction heating by the induction heating coil 302 according to a magnetic field control setpoint, and the AC power supply 304 is configured to control the power level (e.g., current amplitude) according to an AC power setpoint PAC and operating frequency FO of the induction heating coil 302 according to an operating frequency setpoint FO, as well as the processing time according to parameters determined based on a specified or desired thermal profile for the magnetic workpiece 306 including a desired current penetration depth. In operation in one example, the induction heating coil 302 is energized by the AC power supply 304 providing AC current thereto in order to operate at the operating frequency FO, such as 5-100 kHz. The operating frequency FO and output amplitude (e.g., voltage and/or current) are adjustable or programmed in one implementation for a desired heat-treating profile for a particular workpiece 306. In addition, the magnetic field strength of the DC magnetic field 320 is controlled in order to control the permeability of the magnetic workpiece 306 during induction heating.

The described systems 100, 200 and/or 300 can be used in a variety of different applications, including induction thermomagnetic processing (ITM) to improve the microstructure and material properties of the parts being processed due to the direct interaction of the applied DC magnetic field in combination with induction heating. The present disclosure provides solutions to use permeability to control the thermal profile of the part to attain the desired final metallurgical result, rather than the direct magnetic effect on the material properties. In this regard, induction heating frequency can be used to control the thermal profile, service temperature, current penetration depth, etc., and the provision of the DC magnets and the applied DC magnetic field 120, 220, 320 concurrently controls the permeability through the magnetization of the part. As the current depth of penetration is a function of both the workpiece permeability and the induction heating operating frequency FO, the concurrent use of a controlled DC magnetic field and frequency controlled induction heating allows enhanced levels of adjustability to achieve a desired or specified workpiece thermal profile, where the depth of current penetration Delta=2*((Resistivity (rho, micro-ohm cm)/(relative permeability (mu)*frequency (Hertz))\hat{ }5, Delta (inches), Rho (micro-ohm cm), Mu (dimensionless), and Frequency (Hz).

In certain implementations, for example, the workpiece material permeability can easily have an order of magnitude (or several orders of magnitude) change which is relatively easy to implement using a controlled DC magnet, whereas it is very difficult to get an order of magnitude change in frequency without having to change power devices and magnetic components. In one example, the DC magnetic field strength can be set or adjusted to provide course penetration depth control, allowing more granular fine-tuning of the penetration depth by frequency adjustment using an existing induction heating system. For example, an existing induction heating system may be able to accommodate a single order of magnitude change in the operating frequency FO, but this single order of magnitude adjustability may be sufficient to accommodate a wide variety of induction heating applications in combination with adjustment of the DC magnetic field strength. In one aspect, this improved adjustability allows an existing induction heating system to be upgraded by including a DC magnet, in order to accommodate induction heating of a variety of different workpieces which could not have been achieved by simply adjusting the induction heating operating frequency with no DC magnetic field. The disclosed examples accordingly provide significant benefits in terms of cost savings and reduced set up times for individual workpiece types. In addition, the described systems and methods are particularly advantageous compared with dual frequency solutions that required multiple power supplies and associated induction heating components, while providing the benefits of adaptability to accommodate different workpiece induction heating specifications without undue system cost and complexity.

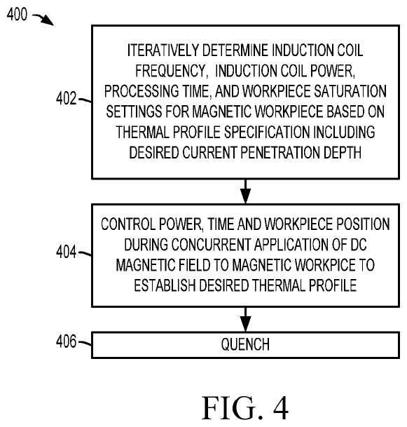

FIG. 4 shows an induction heat treating method 400 for induction heating a magnetic workpiece (e.g., workpiece 106) according to another aspect of this disclosure. The method 400 includes determining an induction heating power, an induction coil operating frequency FO, a processing time, and a strength of the DC magnetic field 120 at 402 based on a thermal profile specification that includes a desired current penetration depth (e.g., Delta) for the magnetic workpiece 106. The determination at 402 may be an iterative process. The method 400 also includes applying a DC magnetic field 120 at 404 to the magnetic workpiece 106 while applying AC current to the induction heating coil 102 to inductively heat the magnetic workpiece 106. In one implementation, the method includes controlling induction heating power, induction coil operating frequency FO, processing time, and the strength of the DC magnetic field 120 applied to the magnetic workpiece 106 to establish a desired thermal profile of the magnetic workpiece 106 in an induction heating process, such as heat treating, tempering, or other processes. In some implementations, the method 400 can also include quenching the magnetic workpiece 106 at 406, for example, by directing a quenching fluid onto the magnetic workpiece 106.

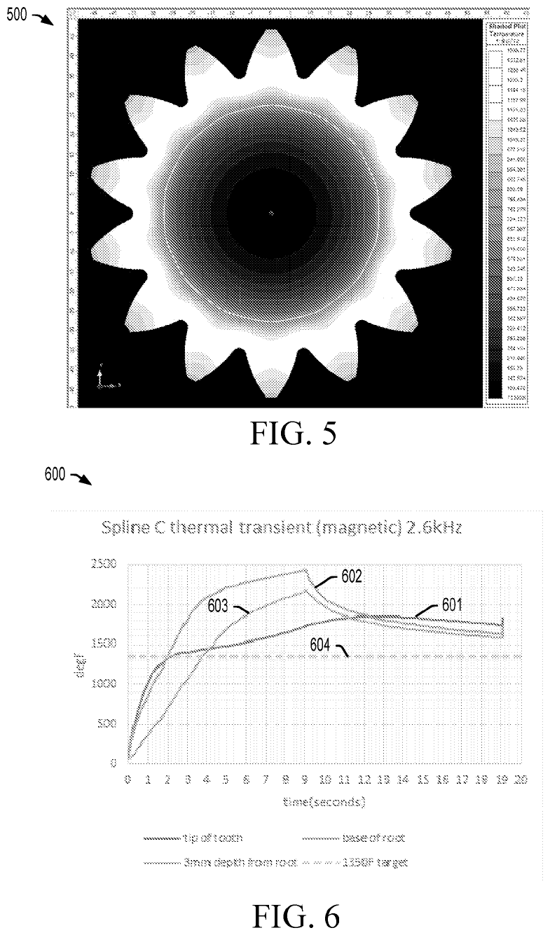

Referring now to FIGS. 5-13, the above concepts have been simulated for use in pinion gear heat treating using a circumferential solenoid induction heating coil (e.g., coil 102 in the system 100 of FIG. 1 for heating the pinion gear shaft magnetic workpiece 106 of FIG. 1A). The addition of the superimposed DC magnetic field 120 operates to effectively reduce the inherent permeability of the magnetic workpiece 106 in proportion to the strength of the applied DC magnetic field 120. This facilitates operation of the concurrently applied induction heating via the induction heating coil 102 in order to allow precise adjustment of the current penetration depth Delta for a specific set of heat treat specifications. In practice, control adjustment of the workpiece permeability renders the magnetic workpiece 106 more easily adapted to the adjustment range of the other components of the induction heating system with respect to induction coil operating frequency FO, induction heating power, processing time, etc. Example simulations illustrated and described below include simulations for the example magnetic workpiece 106 and resulting thermal profiles for simulations in which no DC magnetic field was used, and the magnetic workpiece 106 retains its inherent magnetic properties including permeability (referred to herein as magnetic cases), as well as simulations for the example magnetic workpiece 106 in which a non-zero DC magnetic field 120 was applied concurrently with induction heating via the induction heating coil 102, wherein the magnetic properties of the workpiece 106, including its permeability, were effectively reduced by the applied DC magnetic field 120 (referred to herein as non-magnetic or saturated magnetic cases).

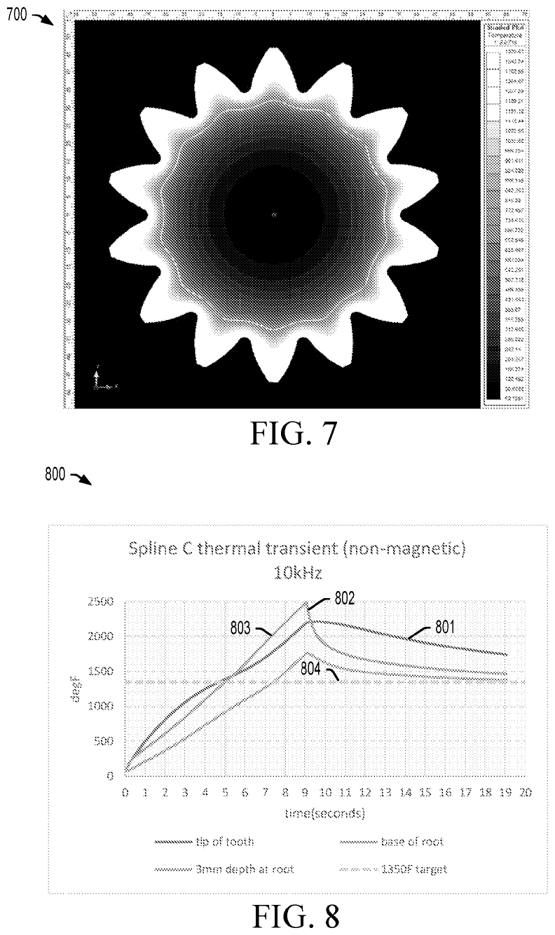

In one example, the shaft heat treat specifications include preferentially ensuring an effective minimum Case depth of 1 mm (50 HRC) for all surfaces, and effective Case depth of 1.25 mm (50 HRC), and as quenched minimum surface hardness of 60 to HRC, gear (e.g., the first spline 106a) minimum heat affected depth of 3 mm, and a minimum heat affected depth of 2.5 mm to 30 HRC for the second spline 106b (FIG. 1A above). In this example, torsional and bending strength are important for the gear workpiece 106, and thus the 3 mm minimum heat affected depth (base material) for the first gear spline 106a and the 2.5 mm minimum effective case (30 HRC) for the second spline 106b. In this example, the same or similar thermal profile can be achieved with a 450 kW induction heating power level at an operating frequency FO of 650 Hz for the magnetic case (with no DC magnetic field) and a 200 kW induction heating power level at an operating frequency FO of 3,000 Hz for the nonmagnetic case (with a non-zero applied DC magnetic field 120). The thermal profile improved from a 2.6 kHz magnetic case (e.g., FIGS. 5 and 6 with no applied DC magnetic field) to the 10 kHz nonmagnetic case (e.g., FIGS. 7 and 8 with a non-zero applied DC magnetic field 120). In general, the optimum operating frequency FO will be dependent on the actual gear profile and the desired specifications, and thus the optimum frequency will change with gear profile. The application of the DC magnetic field 120 partially through the magnetic state provides additional tools for adjusting the final current penetration depth Delta.

FIG. 5 shows a cross-sectional simulated thermal profile 500 of the magnetic workpiece 106 heat treated by induction heating using a solenoid induction coil at a coil frequency of 2.6 kHz without a DC magnetic field. FIG. 6 shows a graph 600 of workpiece temperature as a function of time for the tip of the workpiece tooth (curve 601), the base of the root (curve 602), a 3 mm depth from the root (curve 603) and a target temperature (horizontal line 604) for the workpiece 106 heat treated using the solenoid induction coil 102 at an operating frequency FO of 2.6 kHz without a DC magnetic field. In one implementation, for heating the first spline 106a, a 3-phase power supply 250 kW/kHz can be used with a power set to 220 kW, induction coil frequency 2.6 kHz, scan speed 0.110 inches/second, heat time 9.071 seconds, distance to quench 1.134 inches, quench delay 10.29 seconds, and polymer quench 50 gpm (e.g., gallons per minute flow rate). For the second spline 106b in this example, the 3-phase power supply capable of 250 kW/kHz was used at a power of 156 kW, and induction coil frequency of 2.5 kHz, a scan speed of 0.118 inches/second, a heat time of 8.467 seconds, a distance to quench of 1.728 inches, a quench delay of 14.63 seconds, and a polymer quench applied to the workpiece 106 at a flow rate of 50 gpm.

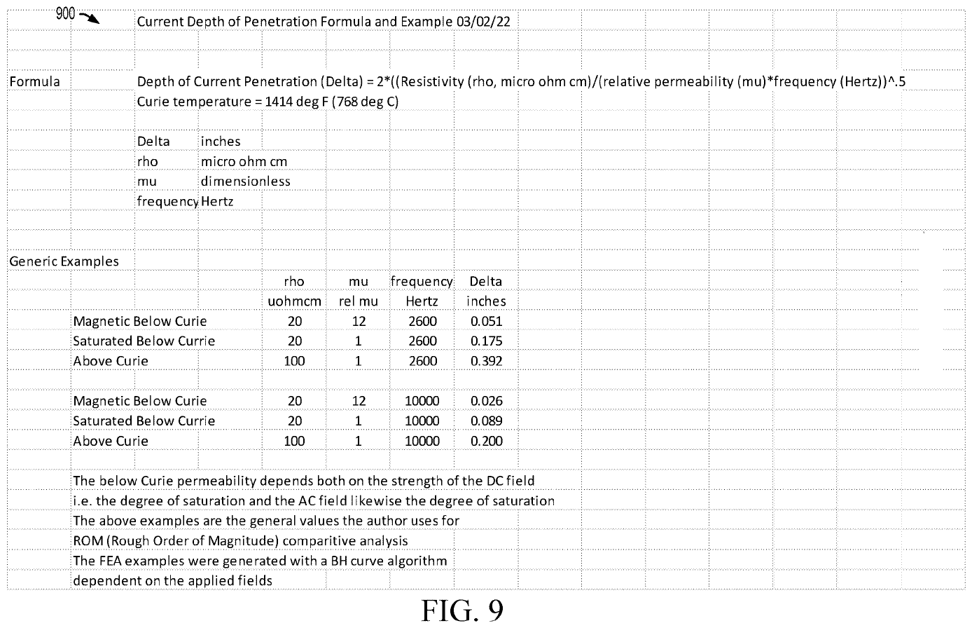

FIG. 7 shows a cross-sectional simulated thermal profile 700 of the magnetic workpiece 106 heat treated using the induction heating system 100 (FIG. 1 above) by induction heating using the solenoid induction coil 102 at a coil operating frequency FO of 10.0 kHz with a 2 Tesla DC magnetic field. FIG. 8 shows a graph 800 of the workpiece temperature as a function of time for the tip of the workpiece tooth (curve 801), the base of the root (curve 802), a 3 mm depth from the root (curve 803) and a target temperature (horizontal line 804) for the magnetic workpiece 106 heat treated using the solenoid induction coil 102 at an operating frequency FO of 10.0 kHz with a 2 Tesla DC magnetic field 120. FIG. 9 shows a table 900 of depth of current penetration formulas and parameters for the simulated cases of FIGS. 5-8.

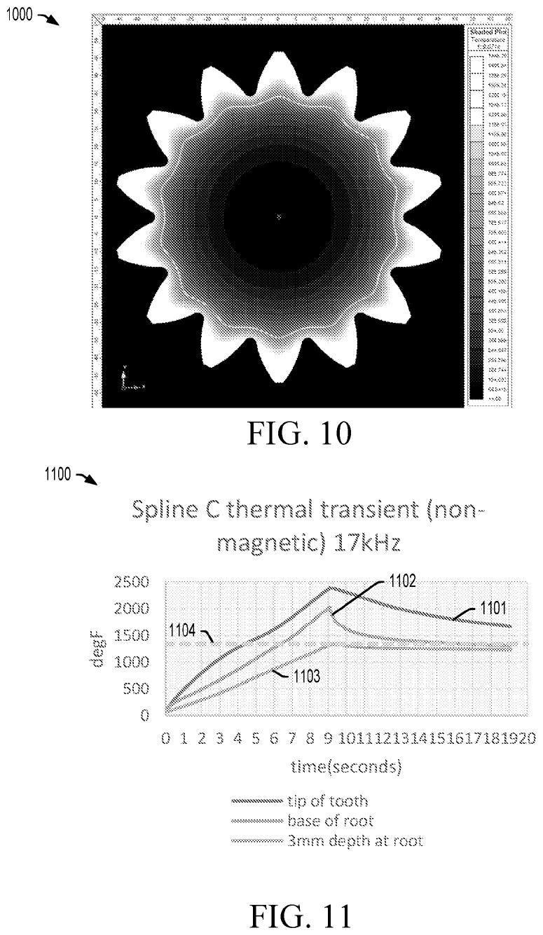

Referring also to FIGS. 10-13, the results in FIGS. 5-9 show simulation (FIGS. 5 and 6) of an existing production process for a magnetic workpiece 106 for comparison to the saturated magnetic process. FIGS. 10-13 further show analysis for heat treating the saturated material of the workpiece 106 at further frequencies, and analysis have been performed from 3 kHz to 20 kHz and with an extended heat time at 20 kHz. In FIGS. 10-13, the 17 and 20 kHz frequencies were examined to avoid quenching the DC magnet, wherein the heat affected limit is assumed to be 1350 deg F.

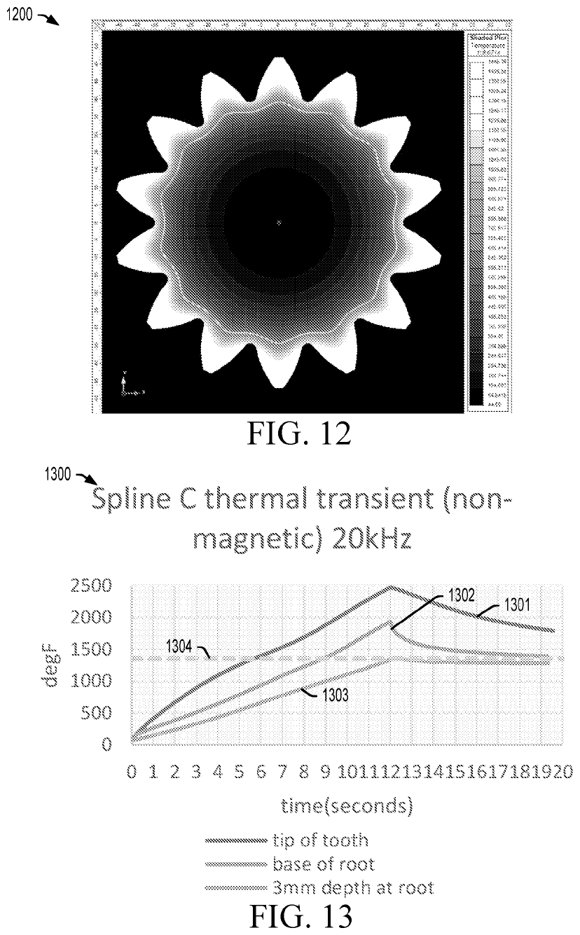

FIG. 10 shows a cross-sectional simulated thermal profile 1000 of the magnetic workpiece 106 heat treated using the induction heating system 100 by induction heating using the solenoid induction coil 102 at a coil operating frequency FO of 17.0 kHz with a 2 Tesla DC magnetic field 120. FIG. 11 shows a graph 1100 of the workpiece temperature as a function of time for the tip of the workpiece tooth (curve 1101), the base of the root (curve 1102), a 3 mm depth from the root (curve 1103) and a target temperature (horizontal line 1104) for the magnetic workpiece 106 heat treated using the solenoid induction coil 102 at an operating frequency FO of 17.0 kHz with a 2 Tesla DC magnetic field 120. FIGS. 12 and 13 show simulated results for another simulated case with an induction coil operating frequency FO of 20 kHz. FIG. 12 shows a cross-sectional simulated thermal profile 1200 of the magnetic workpiece 106 heat treated using the induction heating system 100 by induction heating using the solenoid induction coil 102 at a coil operating frequency FO of 20.0 kHz with a 2 Tesla DC magnetic field 120. FIG. 13 shows a graph 1300 of the workpiece temperature as a function of time for the tip of the workpiece tooth (curve 1301), the base of the root (curve 1302), a 3 mm depth from the root (curve 1303) and a target temperature (horizontal line 1304) for the magnetic workpiece 106 heat treated using the solenoid induction coil 102 at an operating frequency FO of 20.0 kHz with a 2 Tesla DC magnetic field 120.

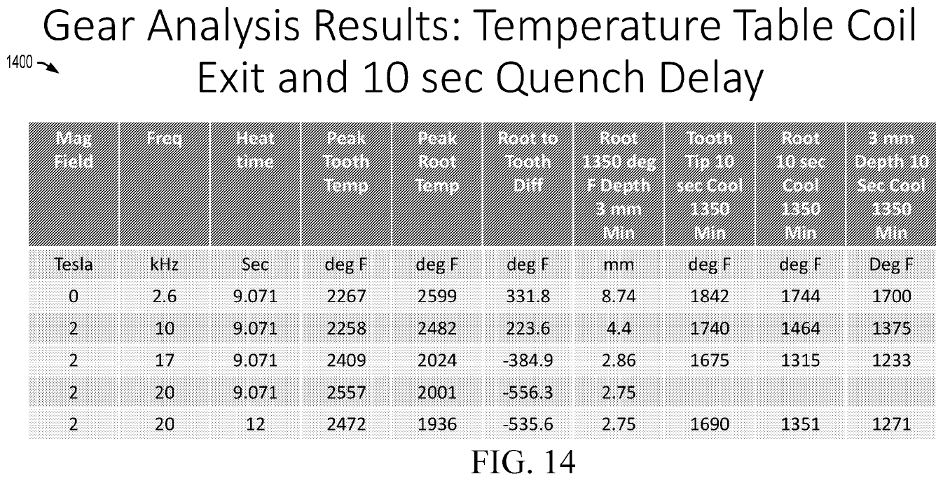

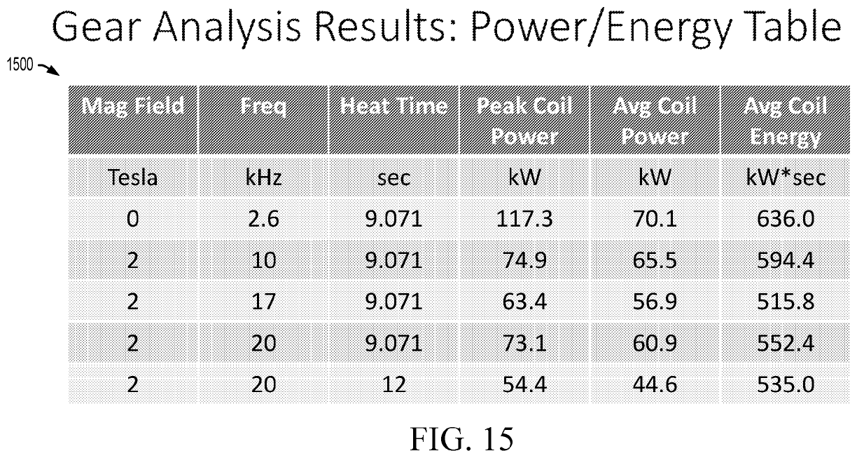

FIG. 14 shows a table 1400 of gear analysis temperature results data temperature for the workpiece 106 heat treated using the solenoid induction coil 102 at the coil operating frequencies of 2.6, 10, 17 and 20 kHz for the simulated cases of FIGS. 5-13. FIG. 15 shows a table 1500 of gear analysis power and energy results data temperature for the workpiece 106 heat treated using solenoid induction coil 102 for the simulated cases of FIGS. 5-13. In the analyzed cases, moreover, extended heat times appear to offer little or no additional benefit at the higher frequencies. In this particular case, moreover, frequencies above 10 kHz may increase the likelihood of overheating the gear teeth relative to the root and may not meet the 3 mm heat affected specification, and the shallow patterns allow the workpiece 106 to cool below acceptable temperature ranges during the scanning quench delay in certain implementations. In this particular simulation of various cases, the saturated workpiece material at 10 kHz appears to offer benefits for a compromise between improved tooth surface hardness and root and 3 mm requirements as long as shallower heat affected and effective case depths are acceptable for torsional and/or bending stresses, and it appears 10 kHz will meet that criteria. In this particular case, moreover, the introduction of the applied DC magnetic field 120 allows the use of the AC power supply 104 and solenoid type induction heating coil 102 designed for operation at or around the 10 kHz frequency range as the recommended frequency without requiring changing or redesigning any of these components other than accommodation of the effects of the applied DC magnetic field 102, for example, on the scanning components 108.

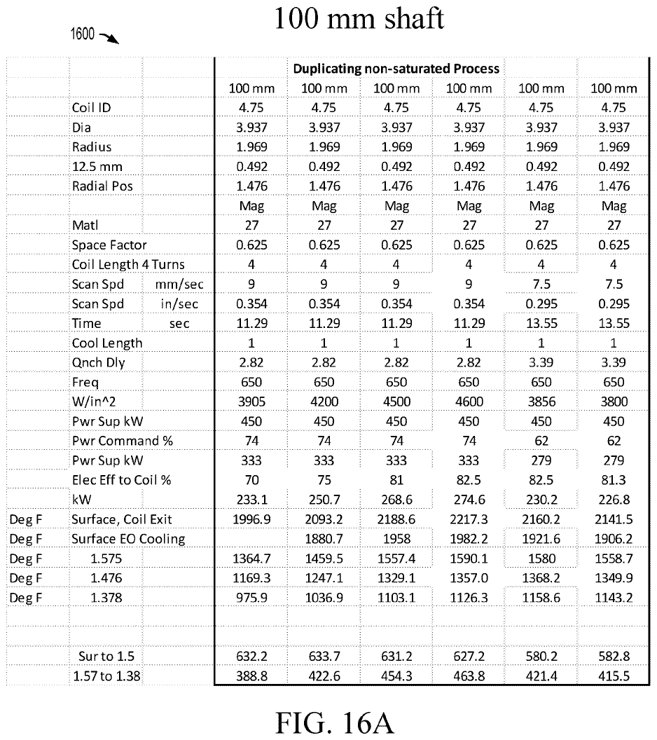

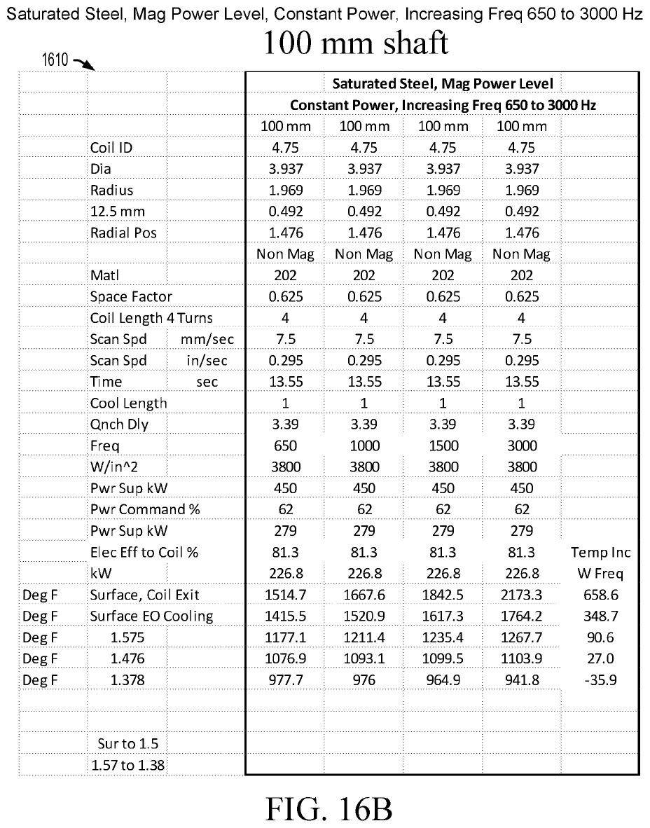

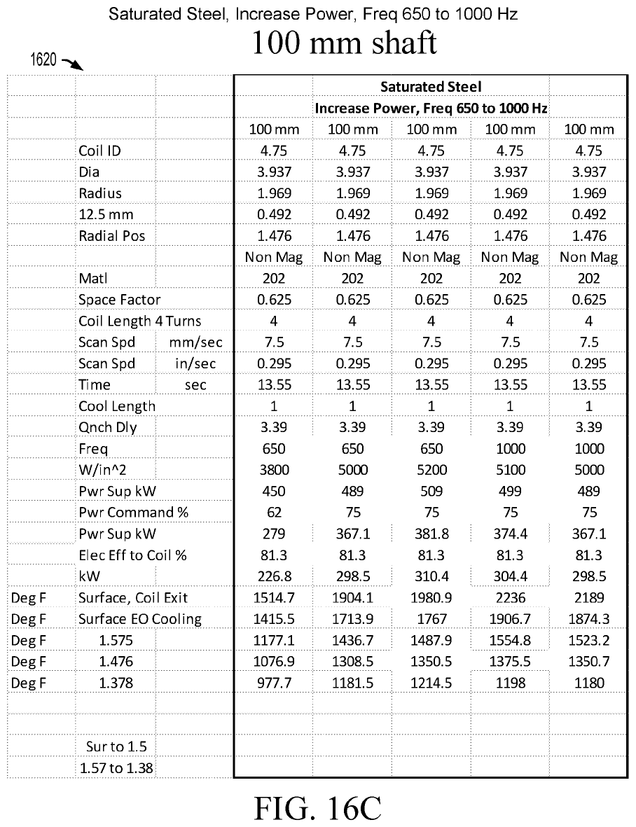

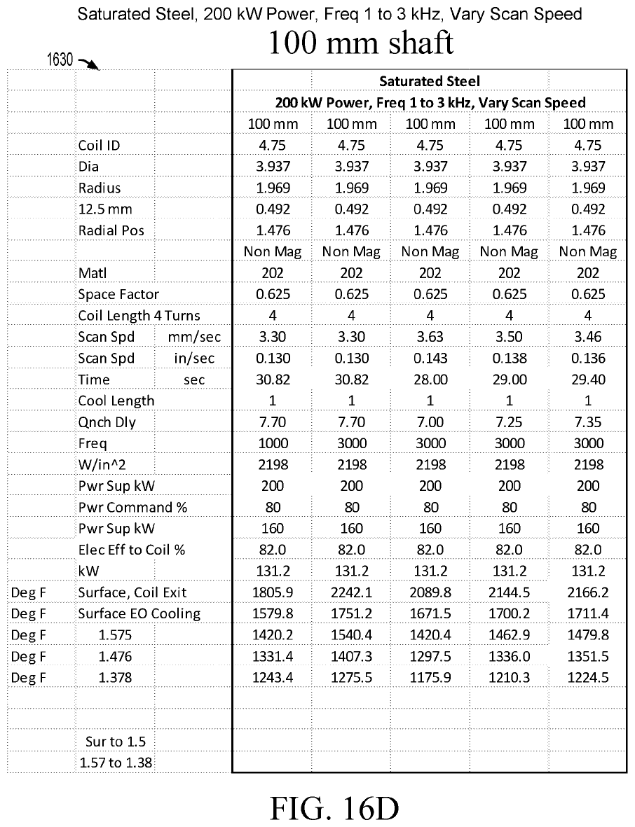

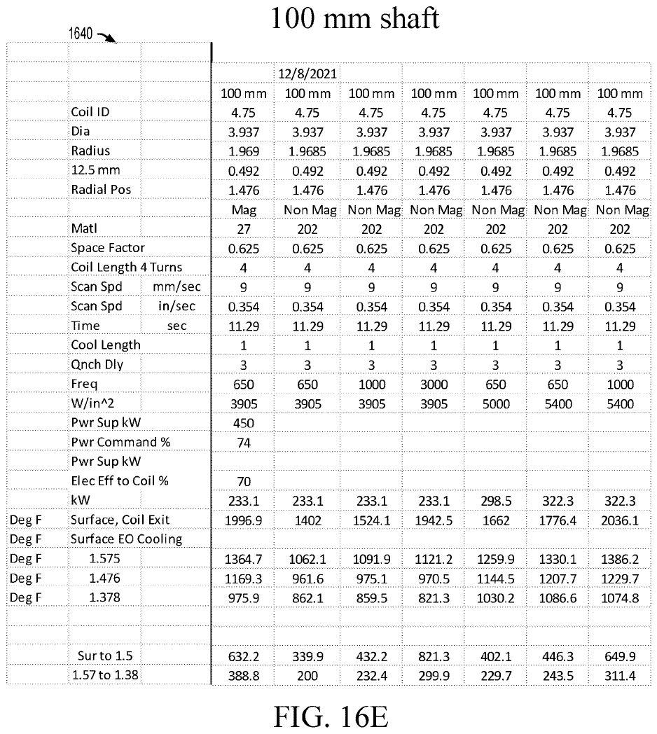

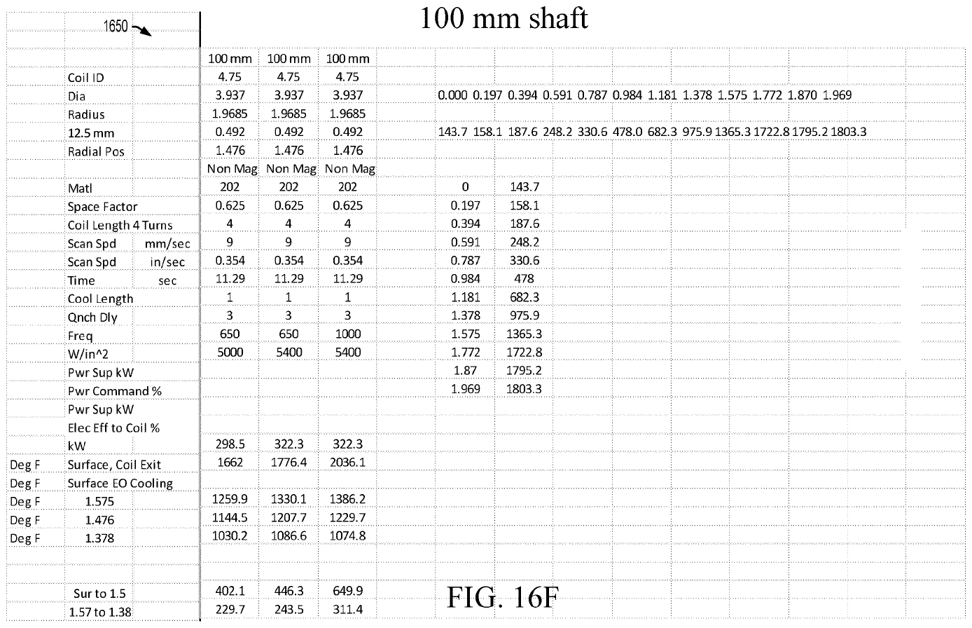

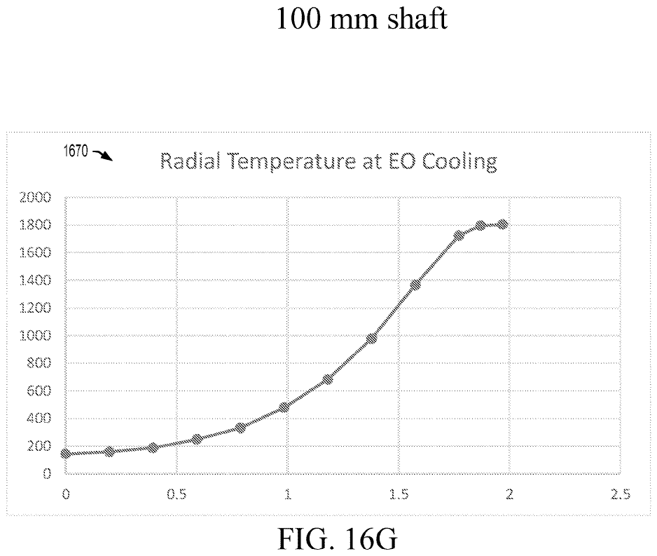

FIGS. 16A-16G demonstrate example data table showing shaft magnetic cycle scanning analysis and parameter optimization for concurrent DC magnetic field and induction heating application for heat treatment using an example 200 kW system. In certain implementations, the determination of the operating parameters for the DC magnet and the induction heating components of the system 100 (e.g., at 402 in the method 400 of FIG. 4 above) can be performed in an iterative manner, although not required for all possible implementations. A table 1600 in FIG. 16A shows parameters associated with duplicating the example non-saturated process (e.g., no DC magnetic field). FIG. 16B shows a table 1610 of saturated steel, magnetic power level, constant power, and increasing frequency from 650 Hz to 3000 Hz. A table 1620 in FIG. 16C shows a further iteration for saturated steel with increased power and frequency increased from 652 1000 Hz. FIG. 16D shows a table 1630 of saturated steel, 200 kW power, and varying scan Speed for frequency increasing from 1 kHz to 3 kHz. In a further iteration, FIG. 16E shows a table 1640 of further simulated parameters, and FIG. 16F shows a table 1650 of additional simulated or computed parameters. FIG. 16G shows a graph 1670 of simulated radial temperature at end of cooling for the example magnetic workpiece 106.

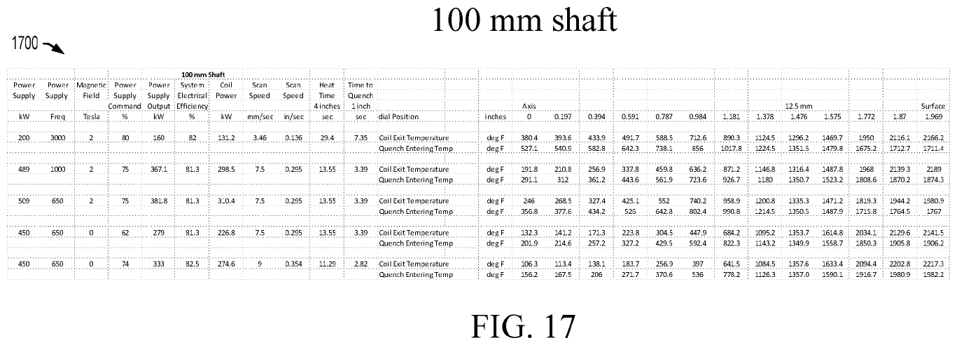

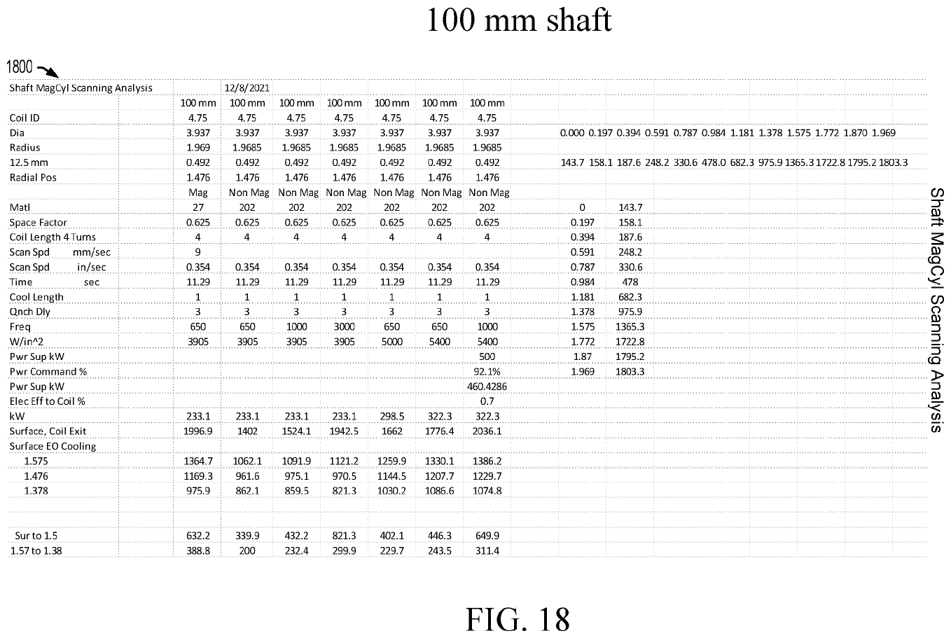

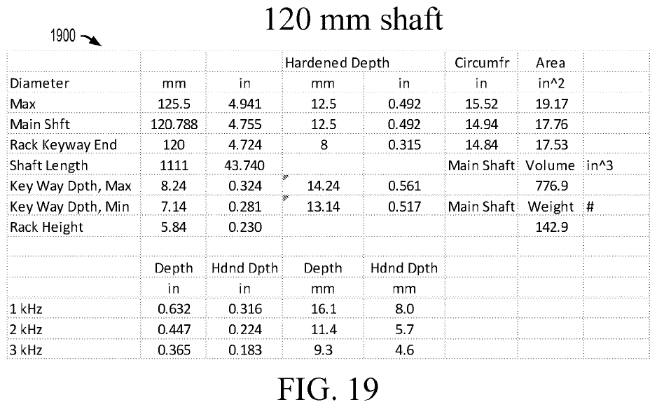

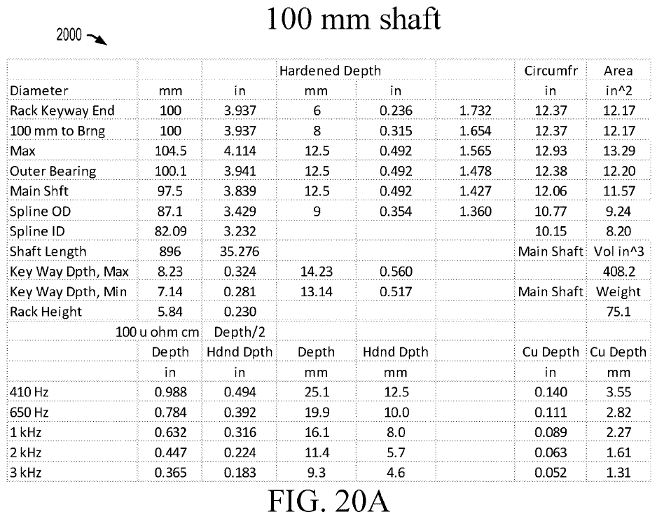

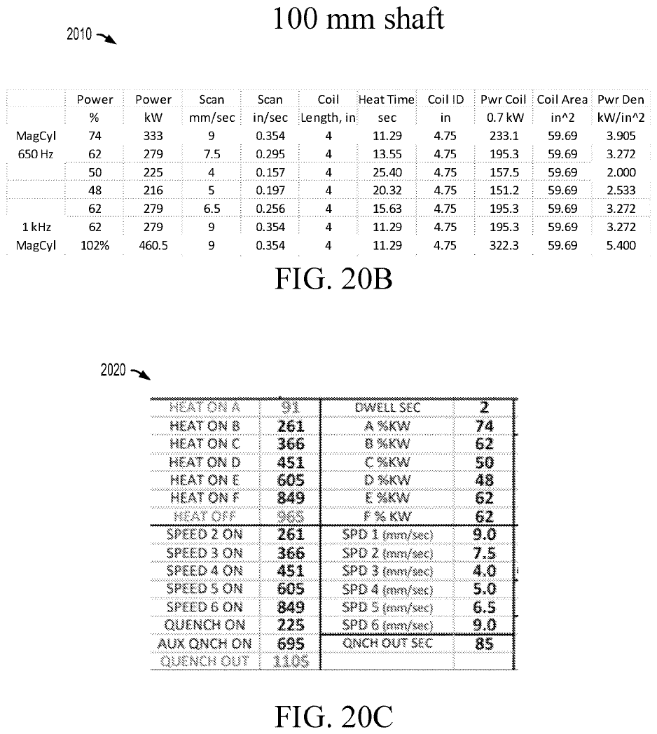

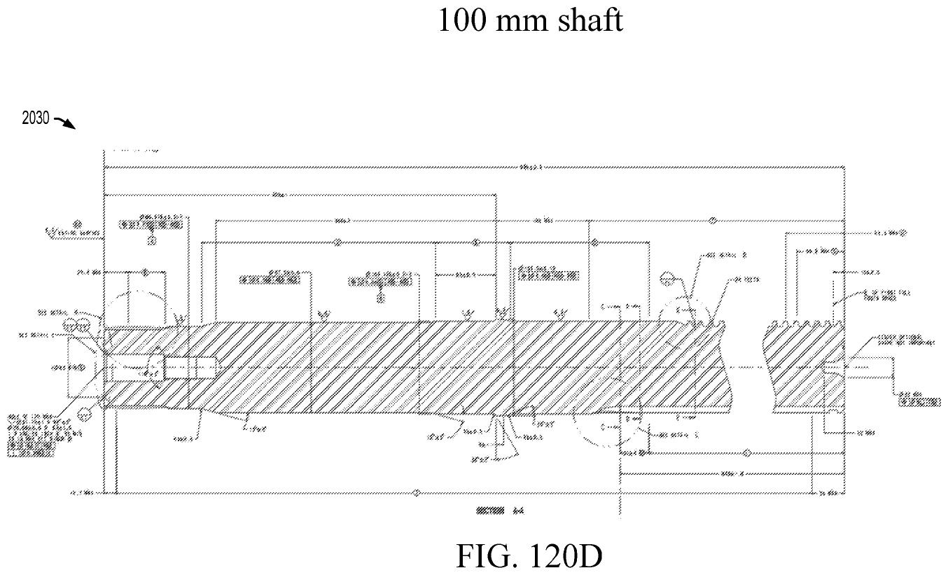

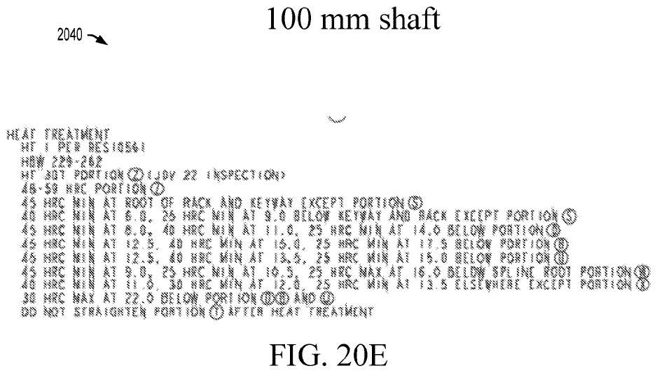

FIG. 17 shows a table 1700 of simulated hardness and penetration depth results for a 100 mm diameter shaft workpiece 106. FIG. 18 shows a table 1800 of preliminary shaft magnetic cycle scanning calculations for a 100 mm diameter shaft. FIG. 19 shows a table 1900 of simulated hardness and penetration depth results for a different workpiece 106 having a 120 mm diameter shaft. FIGS. 20A-20C respectively show tables 2000, 2010 and 2020 of data results for a workpiece 106 having a 100 mm diameter shaft. FIG. 20D is a sectional side view of a workpiece 2030, and FIG. 20E shows a table 2040 of workpiece data for the workpiece 2030 of FIG. 20D.

Heretofore, adaptation of existing induction heating systems for heat treating and/or tempering different workpieces or parts has been a continuing challenge, in part due to the frequency adjustment limitations of AC power supplies used to supply current to induction heating coils. The disclosed examples provide important solutions by introducing controlled DC magnetic fields to control the permeability of the treated magnetic workpiece 106 during induction heating, thus facilitating use of the potentially limited frequency and power adjustment range of the power supply and other components of the existing induction heating system while accommodating a larger variety of different treated parts or workpieces 106. Other uses of concurrent induction heating in the presence of an applied DC magnetic field may only focus on the metallurgical properties (not even including the mechanical properties), but the disclosed examples demonstrate the feasibility of selective use of the applied DC magnetic fields during induction heating to achieve a desired thermal profile including depth of current penetration for a given heat treated workpiece design, as opposed to metallurgical benefits. The disclosed examples, moreover, provide significant benefits with respect to lower cost and lower system complexity compared with dual frequency induction heating approaches.

The described examples additionally show the benefits of evaluating and controlling the workpiece permeability (e.g., saturation controlled by applied DC magnetic field strength) and frequency (depth of current penetration); power, and time variables to attain a previously unrecognized improved process, with much greater adaptability compared with systems that only control induction heating frequency, power and processing time. The disclosed apparatus and techniques open a new avenue of development for induction heating systems generally, and facilitate cost reduction, reduced time to adapt existing systems to induction heat new parts, as well as enabling further development efforts to reduce processing energy usage, time, etc. For example, the continuing use of ITMP processing to improve material properties such as improved microstructure and mechanical properties such as ductility, fatigue strength and yield strength of treated parts as well as to reduce processing time and energy can benefit from the advantages of using applied DC magnetic fields 120.

The disclosed examples provide an avenue to further improve ITMP and other induction heating process is generally by utilizing the application of the DC Field to control the permeability (saturation) of the material and thereby controlling the depth of current penetration and thereby the thermal profile. Prior to the herein described developments, but many induction heating engineers, and research scientist have been studying the application of the ITMP process without recognizing or utilizing this powerful variable. As discussed above, the formula for depth of current penetration demonstrates that control of the level of saturation and thereby the relative permeability of a magnetic workpiece 106 offers a second and more powerful variable to control the process of induction heating. Typical below Curie relative permeability values are on the order of 8 to 20 compared to the fully saturated value of 1, thereby easily an order of magnitude shift in the (mu*frequency) variable can be achieved through the selective application of the DC magnetic field 120. In contrast, to vary the frequency by an order of magnitude requires a power supply with an entirely different set of power devices and magnetic components whereas to vary the relative permeability is merely to control the level of the DC magnetic field strength. As further discussed above, moreover, the disclosed solutions provide significant advantages compared to combining dual frequency power supplies some in sequence and others with simultaneous frequency applications particularly for gears. The described examples make those concepts obsolete through the application of the DC field to control the depth of heating and thereby the heating profile. In addition, the disclosed examples provide the aforementioned advantages compared to mere adjustment of induction heating power, frequency, and processing time, even where the single precise frequency can be optimized (e.g., using “single precise frequency” techniques), as the power supply and system component limitations do not provide a wide range of adjustability without changing hardware. In this regard, the use of dual permeability and frequency control will likely replace the “Single Precise Frequency” with the optimum (permeability*frequency) product approach and adjusting or varying the DC magnetic field in general will require seconds rather than milliseconds so it is visualized the optimum single, mu*frequency, product will be utilized, especially for production shops with variable gears and heat-treating requirements. The concepts of the present disclosure enable use of existing or slightly modified induction heating systems in even the smallest job shop or heat-treating laboratory.

This example of FIGS. 7 and 8 illustrates the advantage of applying the magnetic field 120 both with the thermal image comparison between FIGS. 5 and 7 at the coil exit (e.g., when the workpiece 106 exits the induction heating coil 102) and with the thermal profile charts of FIGS. 6 and 8 which capture the three critical areas: the root where the primary requirement is strength especially fatigue strength, the tip where the principal requirement is surface hardness for wear and contact fatigue, the area from tooth tip to the root of course is a blending of the two requirements (tip to root), and the 3 mm heat effected depth requirement to assure rotational fatigue strength in the base material. The coil in one example is 1″ in length with a 2.8 mm/second scan rate or a 9.071 second heat time followed by the 10.29 seconds scan time to quench. The three curves peak at the coil exit and then decrease due to radiation, convection and conduction cooling prior to the quench (where the quench cooling profile is not shown). The temperature charts clearly show that the magnetic case at 2.6 kHz has a hot root and a cold tip and probably has marginal tooth surface hardness. Various frequencies were studied for the magnetically saturated case, 7 to 20 kHz, and it was clear that 10 kHz was the optimum frequency and results in a balance tooth tip and root temperature while maintaining an adequate 3 mm heat effected temperature. In one application of the present disclosure a Finite Element Analysis (FEA) can be used to compare the magnetic case to the saturated magnetic case, as illustrated in FIGS. 16A-16E to meet or improve on the required part heat treat specifications. In general, in the laboratory applications of this technology, superconducting magnets can be large (e.g., 60″ in diameter by 60″ long) or smaller DC magnets can be used where adequate to generate the DC magnetic field 120, even conventional magnets (not super conducting) allowing the magnets to be incorporated in conventional scanners. In addition, shielding of the induction AC field from the DC magnet could be a copper shield 123, 133 around the smaller magnet, or a larger 60″ long cylinder shield within a superconducting magnet bore.

The disclosed systems and methods can be used in other applications, including without limitation induction heating of complex structures, which can be partially simplified if the part were fully saturated rather than magnetic, less concentrated heating. An additional benefit of the saturation effect for induction heat treating is; often with shafts there are keyways, shoulders etc. that flash heat with the application of the induction heating during the below Curie phase. Whether it is scanning or single shot the application of the DC magnetic field and the saturation effect would reduce this concentrated overheating effect. Moreover, tempering processes can benefit from applied DC magnetic fields (e.g., FIG. 3 above), especially when the hardening cycle is followed with a temper. The current penetration depth can be increased by applying the DC magnetic field 320, and thus the temper time could be reduced, wherein DC magnetic field strength adjustment and the associated permeability control has an order of magnitudes greater effect than frequency adjustment.

The exemplary embodiments have been described with reference to the preferred embodiments. Modifications and alterations will occur to others upon reading and understanding the preceding detailed description. It is intended that the exemplary embodiment be construed as including all such modifications and alterations insofar as they come within the scope of the appended claims or the equivalents thereof.

What is claimed is:

1. An induction heating system, comprising:
an induction heating coil proximate to a workpiece path and configured to operate at an operating frequency to inductively heat a magnetic workpiece; and
a DC magnet having opposite first and second poles respectively facing opposite lateral sides of the magnetic workpiece to apply a DC magnetic field to the magnetic workpiece during induction heating by the induction heating coil.

2. The induction heating system of claim 1, wherein the induction heating coil is a solenoid coil circumferentially surrounding the workpiece path.

3. The induction heating system of claim 1, further comprising a quench system axially spaced apart from the induction heating coil and configured to direct a quench fluid onto the magnetic workpiece.

4. The induction heating system of claim 1, wherein the induction heating coil is a single shot coil having first and second conductors extending parallel to the workpiece path and first and second crossover conductors.

5. The induction heating system of claim 1, comprising an AC power supply configured to control a magnitude and frequency of AC current provided to the induction heating coil during induction heating, and a controller configured to control the strength of the DC magnetic field applied to the magnetic workpiece during induction heating by the induction heating coil.

6. A method for induction heating a magnetic workpiece, the method comprising:
applying a DC magnetic field to a magnetic workpiece while applying AC current to an induction heating coil to inductively heat the magnetic workpiece.

7. The method of claim 6, comprising controlling induction heating power, induction coil operating frequency, processing time, and the strength of the DC magnetic field applied to the magnetic workpiece to establish a desired thermal profile of the magnetic workpiece in an induction heating process.

8. The method of claim 7, wherein the induction heating process is a heat-treating process.

9. The method of claim 7, wherein the induction heating process is a tempering process.

10. The method of claim 7, comprising:
determining the induction heating power, the induction coil operating frequency, the processing time, and the strength of the DC magnetic field based on a thermal profile specification that includes a desired current penetration depth for the magnetic workpiece.

11. The method of claim 7, comprising:
directing a quenching fluid onto the magnetic workpiece.

12. The method of claim 6, comprising:
determining an induction heating power, an induction coil operating frequency, a processing time, and a strength of the DC magnetic field based on a thermal profile specification that includes a desired current penetration depth for the magnetic workpiece.

13. The method of claim 6, comprising:
directing a quenching fluid onto the magnetic workpiece.
